(19) United States
(12) Patent Application Publication
(10) Pub. No.: US 2007/0186716 A1
(43) Pub. Date: Aug. 16, 2007

(54) Angle adjusting assembly of stand tube

(76) Inventor: Chao-Hu Chen, Taichung Hsien (TW)

Correspondence Address: Chao-Hu Chen, 235 Chung - Ho, Box 8-24, Taipei, TW

(21) Appl. No.: 11/353,284

(22) Filed: Feb. 14, 2006

(51) Int. Cl. B62K 21/16

(52) U.S. Cl. 74/551.3

(57) ABSTRACT

An angle adjusting assembly of a stand tube comprises a stand tube having a front end; a penetrating unit passing through the front end; a rear end of the stand tube being formed with a combining portion; an ejection device including a screw rod; a top of the screw rod having an ejection block; a quick-detaching unit having a driving unit and a positioning control unit; the positioning control unit being interacted with the ejection block of the ejection device; and a front forked unit having a pivoted shaft which can be pivotally installed to the combining portion of the stand tube. When the ejection block is driven by the driving unit to move upwards and downwards, the elastic unit below the ejection block will compress the limiting element. Thus the angle between the front forked unit and the stand tube is adjustable.

### FIELD OF THE INVENTION

The present invention relates to stand tubes of bicycles, and in particular to an angle adjusting assembly of a stand tube, wherein the angle between the stand tube and front forked unit can be easily and conveniently adjusted so as to provide a safety and comfortable driving to drivers.

### BACKGROUND OF THE INVENTION

Driving Bicycles is a popular exercise and leisure activity. More and more people exercise by driving bicycles. The structure of bicycle is important in design of bicycle, which can provide a steady driving for the drivers.

In the bicycle, a stand tube is used to combine a front forked unit. Thereby the structure of the stand tube is a main concern to the safety and comfortable driving of the bicycle. In one prior art, a stand tube is formed by a transversal tube and two rings connected to the transversal tube. One ring serves to lock a front forked unit and another ring serves to lock a handle. Each ring has a slit. A screw unit is installed on the slit. When the forked unit is engaged to the slit, the screw unit serves to lock the forked unit to the ring. However in this prior art, the angle of the ring is not adjustable. Thereby the user cannot adjust the angle of the stand tube so as to have a structure suitable of the driving of the user. In another prior art, a slot is formed on the stand tube for receiving a quick-detaching unit. By tightening or releasing the quick-detaching unit, the size of the slot is controllable. However this design will make the stand tube deform for clamping a rod body. For a long time, the material of the stand tube will fatigue. This will affect the safety of the bicycle.

### SUMMARY OF THE INVENTION

Accordingly, the primary object of the present invention is to provide an angle adjusting assembly of a stand tube, wherein the angle between the stand tube and front forked unit can be easily and conveniently adjusted so as to provide a safety and comfortable driving to drivers.

To achieve above objects, the present invention provides an angle adjusting assembly of a stand tube which comprises a stand tube having a front end; a penetrating unit passing through the front end; a rear end of the stand tube being formed with a combining portion; an ejection device including a screw rod passing through the penetrating unit; a top of the screw rod having an ejection block; a quick-detaching unit having a driving unit and a positioning control unit; the positioning control unit being interacted with the ejection block of the ejection device; and a front forked unit having a pivoted shaft which can be pivotally installed to the combining portion of the stand tube. When the ejection block is driven by the driving unit to moves upwards and downwards, the elastic unit below the ejection block will compress the limiting element so that the buckling portion of the limiting element separates from or combined to the teeth portion of the front forked unit. Thus the angle between the front forked unit and the stand tube is adjusted.

The various objects and advantages of the present invention will be more readily understood from the following detailed description when read in conjunction with the appended drawing.

### BRIEF DESCRIPTION OF THE DRAWINGS

FIG. 1 is an exploded perspective view of the angle adjusting assembly of a stand tube of the present invention.

FIG. 2 is a perspective view about the angle adjusting assembly of a stand tube of the present invention.

FIG. 3 is a lateral perspective view about the angle adjusting assembly of a stand tube of the present invention.

FIGS. 4 and 5 are schematic views about the angle adjusting assembly of a stand tube of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

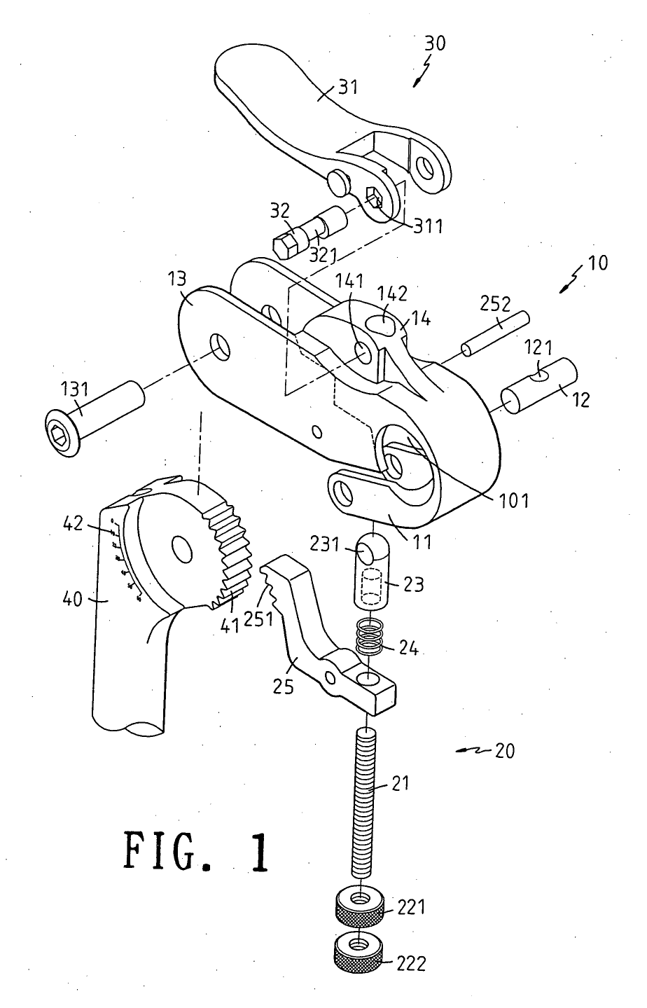

Referring to FIGS. 1 to 5, the angle adjusting assembly of a stand tube according to the present invention is illustrated. The present invention has the following element.

A stand tube 10 has a front end. An engaging hole 101 is formed at a front end. A handle 50 of a bicycle can be installed to the engaging hole 101. A lower end of the engaging hole 101 is formed with two wings 11. A penetrating unit 12 passes through the two wings 11. A penetrating hole 121 is installed in the penetrating unit 12. A rear end of the stand tube 10 is formed with a combining portion 13. The combining portion 13 is formed of two symmetric sheets. By using a pivoted shaft 131, a front forked unit 40 of a bicycle can be installed to the combining portion 13. An upper end of the stand tube 10 is formed with a pivotal portion 14. The pivotal portion 14 has a transversal through hole 141 and a longitudinal through hole 142. The longitudinal through hole 142 passes through the stand tube 10 longitudinally.

The ejection device 20 includes a screw rod 21 passing through the penetrating unit 12. The penetrating unit 12 is passed by the screw rod 21 of the ejection device 20, a first positioning unit 221 is screwed upon an upper side of the penetrating hole 121 and a second positioning unit 222 is screwed upon a lower side of the penetrating hole 121 so as to fix the screw rod 21 to the penetrating unit 12 between the first positioning unit 221 and the second positioning unit 222. A top of the screw rod 21 has an ejection block 23. The ejection block 23 has a passing hole 231. The ejection block 23 is capable of passing through the longitudinal through hole 142 in the pivotal portion 14 of the stand tube 10. The passing hole 231 of the ejection block 23 is aligned to the transversal through hole 141 of the pivotal portion 14. An elastic unit 24 and a limiting element 25 are installed below the ejection block 23 of the screw rod 21. Two ends of the elastic unit 24 resist against the ejection block 23 and the limiting element 25. One end of the limiting element 25 is sleeved to the screw rod 21 and another end thereof is formed with a buckling portion 251. A middle section of the limiting element 25 is pivoted to the stand tube 10 by using a pivotal shaft 252.

A quick-detaching unit 30 has a driving unit 31 and a positioning control unit 32. Two sides of one end of the driving unit 31 have through holes 311 for installing the positioning control unit 32. One through hole 123 of the quick-detaching unit 30 has a polygonal edge so that the driving unit 31 can drive the positioning control unit 32. The positioning control unit 32 is a rod. One end of the positioning control unit 32 is installed with a polygonal post corresponding to the through hole 311 of the driving unit 31. A middle section of the positioning control unit 32 is more slender than other portion thereof to be as an eccentric shaft 321. A size of the eccentric rod 321 is identical to that of the passing hole 231 of the ejection block 23. The positioning control unit 32 passes through the transversal through hole 141 of the pivotal portion 14 and the eccentric rod 321 is combined to the passing hole 231 of the ejection block 23. Thus, the driving unit 31 is pivoted to the stand tube 10. When driving the driving unit 31, the eccentric shaft 321 of the positioning control unit 32 will drive the ejection block 23 to move upwards and downwards.

A front forked unit 40 has a pivoted shaft 131 which can be pivotally installed to the combining portion 13 of the stand tube 10. Moreover the front forked unit 40 is rotatable with respect to the combining portion 13. An upper end of the front forked unit 40 is formed with a teeth portion 41 capable of being engaged to the buckling portion 251 of the limiting element 25. The front forked unit 40 is formed with a plurality of angle indications 42. Thereby when the angle between the front forked unit 40 and the stand tube 10 is adjusted, the angle can be illustrated from the angle indications 42 of the front forked unit 40.

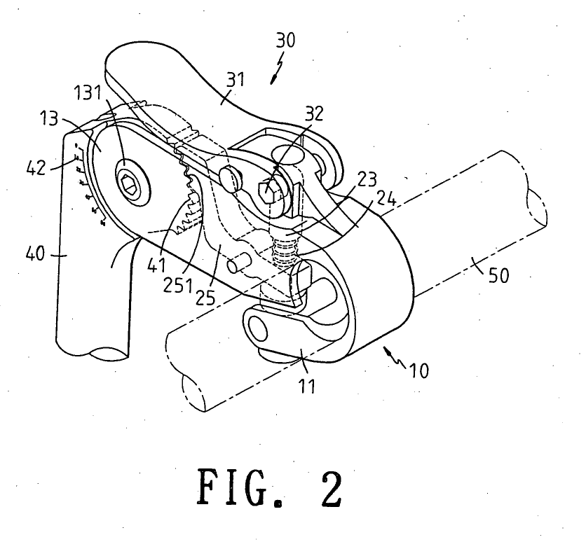

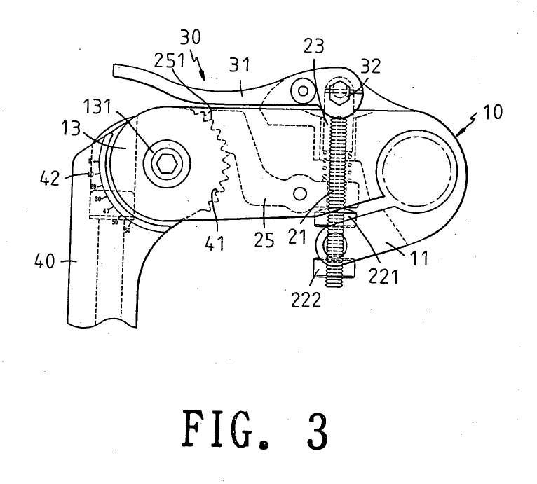

In assembly of the present invention, the penetrating unit 12 is installed between the two wings 11. Then the limiting element 25 is pivotally installed to the stand tube 10 by using the pivotal shaft 252. The screw rod 21 passes through the penetrating hole 121 of the penetrating unit 12. An upper end and a lower end of the penetrating unit 12 are screwed with the first positioning unit 221 and the second positioning unit 222. The limiting element 25 and elastic unit 24 sleeve the screw rod 21. Finally the ejection block 23 locks a top end of the screw rod 21. Thereby the passing hole 231 of the ejection block 23 is aligned to the transversal through hole 141 of the pivotal portion 14 of the stand tube 10. Then the through hole 311 of the driving unit 31 is aligned to the transversal through hole 141 of the pivotal portion 14 of the stand tube 10. The positioning control unit 32 passes through the through hole 311 of the driving unit 31, the transversal through hole 141 of the pivotal portion 14 and the passing hole 231 of the ejection block 23 so that the driving unit 31 is pivoted to the stand tube 10. Then the eccentric rod 321 of the positioning control unit 32 is combined with the passing hole 231 of the ejection block 23. When the driving unit 31 drives an object, the positioning control unit 32 will drive the ejection block 23 to displace upwards and downwards. Finally, the pivoted shaft 131 serves to pivotally install the front forked unit 40 to the combining portion 13 of the stand tube 10. Thus the assembly work is complete. The assembly views are illustrated in FIGS. 2 and 3.

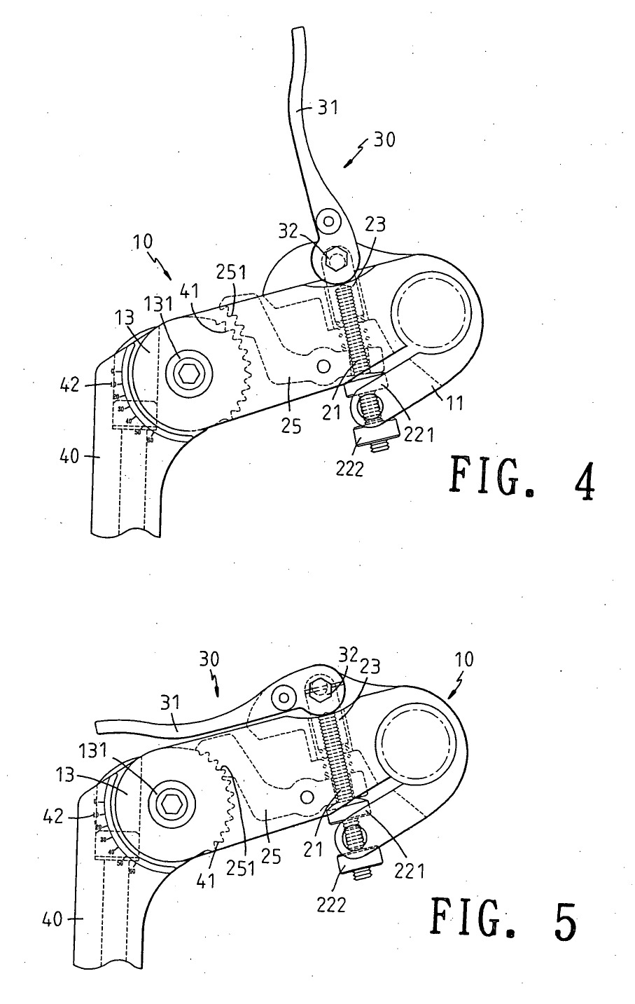

With reference to FIGS. 3 to 5, in use of the present invention, the driving unit 31 is adhered to the stand tube 10. The ejection block 23 of the ejection device 20 is positioned at a higher place since the passing hole 231 is combined with the eccentric shaft 321 of the positioning control unit 32. The screw rod 21 screwed to the ejection block 23 is also pulled with a length. Then the second positioning unit 222 at the lower end of the screw rod 21 resists against the penetrating unit 12. The limiting element 25 is retained to be in a state that the buckling portion 241 is engaged to the teeth portion 41 of the front forked unit 40. When it is desired to adjust the angle between the front forked unit 40 and the stand tube 10. The driving unit 31 can be moved upwards. Then the eccentric shaft 321 of the positioning control unit 32 is at a lower position due to rotation. Therefore, the ejection block 23 of the ejection device 20 will move downwards with the eccentric shaft 321 since the passing hole 231 is combined with the eccentric shaft 321 of the positioning control unit 32. The screw rod 21 screwed to the ejection block 23 will move downwards so that the first positioning unit 221 of the screw rod 21 resists against the penetrating unit 12. Since the middle section of the limiting element 25 is pivoted to the stand tube 10, when the end of the pivotal portion 14 engaged to the screw rod 21 is pushed downwards by the ejection block 23 through the elastic unit 24, another end of the limiting element 25 moves forwards slightly (referring to FIG. 4) to separate from the teeth portion 41 of the front forked unit 40. Thereby the front forked unit 40 will not confine by the buckling portion 251 of the limiting element 25. It is rotatable and adjustable. When it is adjusted to a desired angle, the driving unit 31 is driven to move downwards to be adhered to the stand tube 10 so that the ejection block 23 and the screw rod 21 are pulled upwards. The buckling portion 251 of the limiting element 25 will fall downwards again to be engaged to the teeth portion 41 of the front forked unit 40. Thereby the front forked unit 40 is positioned and is not rotatable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An angle adjusting assembly of a stand tube comprising:
a stand tube having a front end; a penetrating unit passing through the front end; a rear end of the stand tube being formed with a combining portion; by using a pivoted shaft, a front forked unit of a bicycle can be installed to the combining portion;
an ejection device including a screw rod passing through the penetrating unit; a top of the screw rod having an ejection block; an elastic unit and a limiting element being installed below the ejection block of the screw rod; two ends of the elastic unit resisting against the ejection block and the limiting element; on end of the limiting element being sleeved to the screw rod and another end thereof being formed with a buckling portion;
a quick-detaching unit having a driving unit and a positioning control unit; the positioning control unit being interacted with the ejection block of the ejection device; when driving the driving unit, the eccentric shaft of the positioning control unit will drive the ejection block to move upwards and downwards;
a front forked unit having a pivoted shaft which can be pivotally installed to the combining portion of the stand tube; the front forked unit being rotatable with respect to the combining portion; an upper end of the front forked unit being formed with a teeth portion capable of being engaged to the buckling portion of the limiting element; when the ejection block is driven by the driving unit to moves upwards and downwards, the elastic unit below the ejection block will compress the limiting element so that the buckling portion of the limiting element separates from or combined to the teeth portion of the front forked unit; thus the angle between the front forked unit and the stand tube is adjustable.

2. The angle adjusting assembly of a stand tube as claimed in claim 1, wherein as the penetrating unit is passed by the screw rod of the ejection device, a first positioning unit is screwed to the screw rod to be located upon an upper side of the penetrating hole and a second positioning unit is screwed to the screw rod to be located upon a lower side of the penetrating hole so as to fix the screw rod to the penetrating unit between the first positioning unit and the second positioning unit.

3. The angle adjusting assembly of a stand tube as claimed in claim 1, wherein the ejection block has a passing hole; and the quick-detaching unit is a rod; a middle section of the positioning control unit is more slender than other portion thereof to be as an eccentric shaft; the eccentric rod is combined to the passing hole of the ejection block; thus, the driving unit is pivoted to the stand tube; when driving the driving unit, the eccentric shaft of the positioning control unit will drive the ejection block to move upwards and downwards.

4. The angle adjusting assembly of a stand tube as claimed in claim 1, wherein the front forked unit is formed with a plurality of angle indications; thereby when the angle between the front forked unit and the stand tube is adjusted, the angle is illustrated from the angle indications of the front forked unit.

5. The angle adjusting assembly of a stand tube as claimed in claim 1, wherein the combining portion is formed of two symmetric sheets.

6. The angle adjusting assembly of a stand tube as claimed in claim 1, wherein an engaging hole is formed at a front end of the stand tube; and a handle of a bicycle is installed to the engaging hole.

7. The angle adjusting assembly of a stand tube as claimed in claim 1, wherein a middle section of the limiting element is pivoted to the stand tube by using a pivoted shaft, when the end of the pivotal portion engaged to the screw rod is pushed downwards by the ejection block through the elastic unit, another end of the limiting element moves to separate from or combined to the teeth portion of the front forked unit.

8. The angle adjusting assembly of a stand tube as claimed in claim 1, wherein an upper end of the stand tube is formed with a pivotal portion; the pivotal portion has a transversal through hole and a longitudinal through hole; and the longitudinal through hole passes through the stand tube longitudinally.

9. The angle adjusting assembly of a stand tube as claimed in claim 1, wherein two sides of one end of the driving unit have through holes for installing the positioning control unit; one through hole of the quick-detaching unit has a polygonal edge so that the driving unit can drive the positioning control unit; the positioning control unit is a rod; one end of the positioning control unit is installed with a polygonal post corresponding to the through hole of the driving unit; and the positioning control unit passes through the transversal through hole of the pivotal portion and the eccentric rod is combined to the passing hole of the ejection block; and thus, the driving unit is pivoted to the stand tube.
